(19) United States
(12) Patent Application Publication
(10) Pub. No.: US 2016/0363471 A1
(43) Pub. Date: Dec. 15, 2016

(54) NON-INTRUSIVE FLOW MEASUREMENT AND DETECTION SYSTEM

(71) Applicants: Andre Olivier, Chandler, AZ (US); Nicholas Olivier, Maricopa, AZ (US); William Dopson, Chandler, AZ (US)

(72) Inventors: Andre Olivier, Chandler, AZ (US); Nicholas Olivier, Maricopa, AZ (US); William Dopson, Chandler, AZ (US)

(21) Appl. No.: 15/155,895

(22) Filed: May 16, 2016

Related U.S. Application Data
(60) Provisional application No. 62/173,173, filed on Jun. 9, 2015.

(51) Int. Cl. G01F 1/20

(52) U.S. Cl. CPC G01F 1/20

(57) ABSTRACT

A non-intrusive flow measurement and detection device is provided. The device includes a first transducer; a second transducer; and detection/reporting circuitry coupled to the first and second transducers. The non-intrusive flow measurement and detection device is mounted to a pipe or conduit with the first and second transducers in contact with an outer surface of the pipe or conduit. The first transducer detects and measures vibration in the pipe or conduit in response to gas or liquid flowing through the pipe or conduit. The second transducer detects and measures sound in the pipe or conduit in response to gas or liquid flowing through the pipe or conduit. The detection/reporting circuitry compares the measured flow and flow rate determined by the first and second transducers with established limits to determine if the flow and flow rate is within the established limits.

### CROSS REFERENCE TO RELATED APPLICATION[S]

This application claims priority to U.S. Provisional Patent Application No. 62/173,173 to Olivier et al. entitled “OSIRIS-NON-INTRUSIVE FLOW MEASUREMENT AND DETECTION SYSTEM”, filed Jun. 9, 2015, which application is incorporated herein by reference.

### BACKGROUND OF THE INVENTION

Technical Field

This invention relates generally to a flow measurement and detection system and more particularly to a non-intrusive flow measurement and detection system.

State of the Art

Typically, the only method to determine and measure of flow of gasses or liquids in pipes and conduits is to mount a measurement device inside the pipe or conduit. This method requires modification of the pipe or conduit to insert a flow measuring device. Inserting any device into a pipe or conduit will result in some level of flow restriction and will introduce additional turbulence. The result is less flow is achieved by trying to measure said flow.

Accordingly, there is a need for an improved non-intrusive flow measurement and detection system that does not require inserting any device into a pipe or conduit.

### SUMMARY OF THE INVENTION

The present invention relates to a non-intrusive device for flow measurement and detection. The system detects and measures flow of a gas or liquid through a pipe or conduit without the need of inserting a device within the pipe or conduit.

An embodiment includes a non-intrusive flow measurement and detection device comprising: a transducer; and detection/reporting circuitry coupled to the transducer, wherein: the non-intrusive flow measurement and detection device is mounted to a pipe or conduit with the transducer in contact with an outer surface of the pipe or conduit; the transducer determines the presence of flow of a gas or liquid through the pipe or conduit and measures the flow rate; and the detection/reporting circuitry compares the measured flow rate with established limits to determine if the flow rate is within the established limits.

Another embodiment includes a non-intrusive flow measurement and detection device comprising: a first transducer; a second transducer; and detection/reporting circuitry coupled to the first and second transducers, wherein: the non-intrusive flow measurement and detection device is mounted to a pipe or conduit with the first and second transducers in contact with an outer surface of the pipe or conduit; the first transducer detects and measures vibration in the pipe or conduit in response to gas or liquid flowing through the pipe or conduit; the second transducer detects and measures sound in the pipe or conduit in response to gas or liquid flowing through the pipe or conduit; and the detection/reporting circuitry compares the measured flow and flow rate determined by the first and second transducers with established limits to determine if the flow and flow rate is within the established limits.

Yet another embodiment includes a method of using non-intrusive flow measurement and detection device, the method comprising: measuring flow and a flow rate of gas or liquid through a pipe or conduit with a non-intrusive flow measurement and detection device that does not engage the flow of the gas or liquid; comparing the flow and flow rate to established limits; and reporting the comparison of the measured flow and flow rate with the established limits to an interface.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is side view of a non-intrusive device mounted on the exterior surface of a pipe or conduit, in accordance with embodiments of the present invention;

FIG. 2 is an internal side view of a non-intrusive device mounted on the exterior surface of a pipe or conduit, in accordance with embodiments of the present invention; and

FIG. 3 is a flow chart depicting a method of operating a non-intrusive device, in accordance with embodiments of the present invention.

### DETAILED DESCRIPTION OF EMBODIMENTS OF THE INVENTION

As discussed above, embodiments of the present invention relate to non-intrusive device for flow measurement and detection. The system detects and measures flow of a gas or liquid through a pipe or conduit without the need of inserting a device within the pipe or conduit.

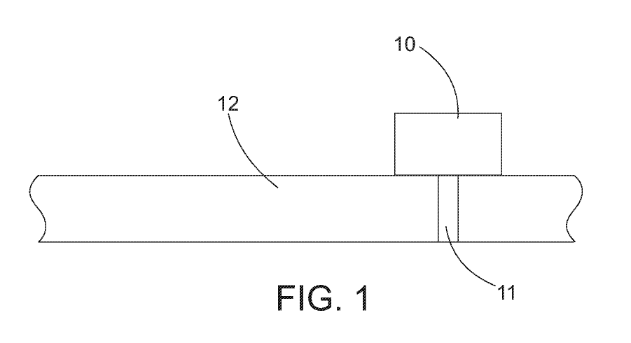

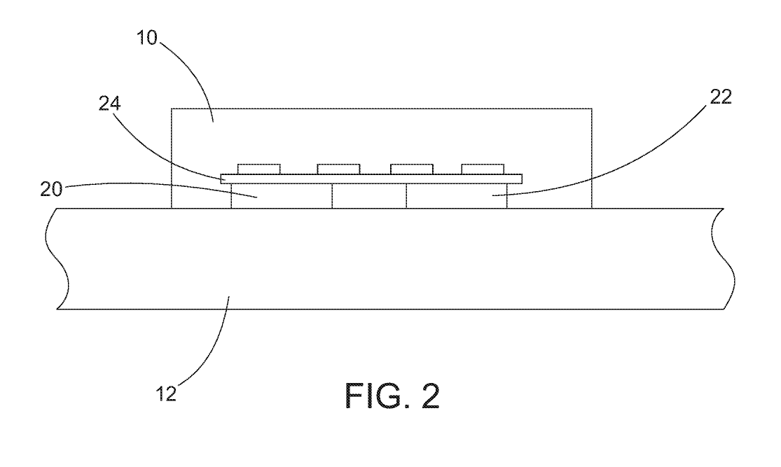

Referring to the drawings, FIGS. 1 and 2 depict an embodiment of a non-intrusive device 10 designed to detect and/or measure flow of gasses or liquids inside a pipe or conduit 12. The device 10 is attached to the outside of the pipe or conduit 12 with an attachment device 11. The attachment device 11 may be a strap, a plastic tie, a zip-tie or the like. The device 10 uses a variety of techniques to make flow measurements, including, but not limited to mechanical techniques, electrical techniques or both. The result is uninhibited flow of gasses or liquids in and through the pipe or conduit 12, while still accurately and effectively determining the volume of flow and the rate of flow through the pipe or conduit 12. This device 10 is much more cost effective as it requires no modification to the flow system itself, but rather simply coupling the device 10 to a pipe or conduit 12 of the flow system.

Flow detection and measurement is achieved by the device 10 detecting sound or vibration or both caused by the flow of gas or liquid inside the pipe or conduit 12. The device 10 may comprise a first transducer 20 and/or a second transducer 22. The transducers 20 and/or 22 may be coupled to the pipe or conduit 12 in a manner wherein the transducers 20 and/or 22 are in contact with the outside surface of the pipe or conduit 12, and therefore requires no drilling or other modifications to the pipe or conduit 12. The first transducer 20 may be piezoelectric device that is used to measure vibration, and the second transducer may be a sound measuring device, such as, but not limited to a microphone used to measure sound. With certain gasses or liquids, either vibration or sound detection may provide an advantage in accuracy; therefore, the device 10 may include one of the first transducer 20, the second transducer 22 or both the first and second transducers 20 and 22.

The non-intrusive device 10 may include detection/reporting circuitry 24 that operates to report the measurement and/or flow detection of the first transducer 20 and/or the second transducer 22. The detection/reporting circuitry 24 can be fitted with a local signal indicator, such as a meter, LEDs, alarm, or other interface viewable by a user to signal or indicate the flow or flow rate. The detection/reporting circuitry 24 may also remotely report flow or flow rate via standards communication protocols, such as, but not limited to—Ethernet, SPI, Serial, I2C, USB, WIFI, ZigBee, WLAN or Cellular device. The device 10 can thus be used locally, or remotely, anywhere in the world and provide reporting to the user regarding the detection of flow and the flow rate through the pipe or conduit 12.

The device 10 can be used autonomously, or in conjunction with another command and control system. The design integrates easily into any existing or future system and can adapt to emerging technologies. Additionally, the device 10 can be solar powered, battery powered or powered via a standard power supply. The device 10 can be manufactured for inside or outside use.

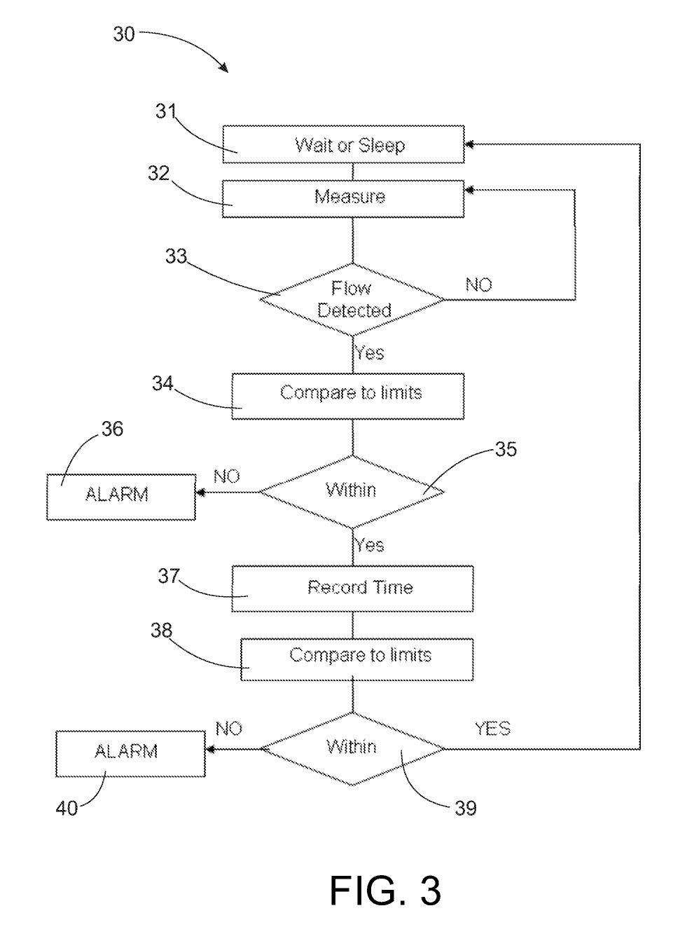

Referring to the drawings further, FIG. 3 demonstrates a flow chart of a possible method 30 of using a non-intrusive device 10 in accordance with embodiments of the present invention. The method 30 may include waiting or sleeping until activation of the non-intrusive device 10 (Step 31). The device may be activated and the method 30 may include measuring flow (Step 32). In order to measure flow, the method 30 includes making a determination as to whether flow is detected (Step 33). If flow is not detected, the method 30 includes performing Step 32 of measuring to determine if there is flow. If flow is detected at Step 32, then the method 30 includes comparing the measurement to the limits of gas or liquid flowing through the pipe or conduit (Step 34). The method 30 includes making a determination if the measurement is within the limits (Step 35). If the measurement is not within the limits at Step 35, then an alarm is activated (Step 36). If the measurement is within the limits at Step 35, then the device 10 operates to record the time of the measurement (Step 37). The method 30 may then include comparing to the limits again (Step 38). The method 30 then includes making a determination if the measurement is within the limits (Step 39). If the measurement is not within the limits at Step 39, then an alarm is activated (Step 40). If the measurement is within the limits at Step 39, then the device 10 goes into a wait or sleep mode reflected as Step 31.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A non-intrusive flow measurement and detection device comprising:
a transducer; and
detection/reporting circuitry coupled to the transducer, wherein:
the non-intrusive flow measurement and detection device is mounted to a pipe or conduit with the transducer in contact with an outer surface of the pipe or conduit;
the transducer determines the presence of flow of a gas or liquid through the pipe or conduit and measures the flow rate; and
the detection/reporting circuitry compares the measured flow rate with established limits to determine if the flow rate is within the established limits.

2. The device of claim 1, wherein the transducer detects and measures vibration in the pipe or conduit in response to gas or liquid flowing through the pipe or conduit.

3. The device of claim 1, wherein the transducer detects and measures sound in the pipe or conduit in response to gas or liquid flowing through the pipe or conduit.

4. The device of claim 1, wherein the transducer is a piezoelectric device.

5. The device of claim 1, wherein the transducer is a microphone.

6. The device of claim 1, wherein the detection/reporting circuitry reports a flow and flow rate of the gas or liquid through the pipe or conduit to a signal interface.

7. The device of claim 1, wherein the detection/reporting circuitry reports a flow and flow rate of the gas or liquid through the pipe to a remote location.

8. A non-intrusive flow measurement and detection device comprising:
a first transducer;
a second transducer; and
detection/reporting circuitry coupled to the first and second transducers, wherein:
the non-intrusive flow measurement and detection device is mounted to a pipe or conduit with the first and second transducers in contact with an outer surface of the pipe or conduit;
the first transducer detects and measures vibration in the pipe or conduit in response to gas or liquid flowing through the pipe or conduit;
the second transducer detects and measures sound in the pipe or conduit in response to gas or liquid flowing through the pipe or conduit; and
the detection/reporting circuitry compares the measured flow and flow rate determined by the first and second transducers with established limits to determine if the flow and flow rate is within the established limits.

9. The device of claim 8, wherein the first transducer is a piezoelectric device.

10. The device of claim 8, wherein the second transducer is a microphone.

11. The device of claim 8, wherein the detection/reporting circuitry reports a flow and flow rate of the gas or liquid through the pipe or conduit to a signal interface.

12. The device of claim 11, wherein the signal interface is one of a meter, LEDs or an alarm.

13. The device of claim 8, wherein the detection/reporting circuitry reports a flow and flow rate of the gas or liquid through the pipe to a remote location.

14. The device of claim 13, wherein the detection/reporting circuitry reports the flow and flow rate to a remote location through one of Ethernet, SPI, Serial, I2C, USB, WIFI, ZigBee, WLAN or Cellular device.

15. A method of using non-intrusive flow measurement and detection device, the method comprising:
measuring flow and a flow rate of gas or liquid through a pipe or conduit with a non-intrusive flow measurement and detection device that does not engage the flow of the gas or liquid;
comparing the flow and flow rate to established limits; and
reporting the comparison of the measured flow and flow rate with the established limits to an interface.

16. The method of claim 15, wherein measuring the flow and flow rate comprises detecting and measuring vibration in the pipe or conduit in response to gas or liquid flowing through the pipe or conduit.

17. The method of claim 15, wherein measuring the flow and flow rate comprises detecting and measuring sound in the pipe or conduit in response to gas or liquid flowing through the pipe or conduit.

18. The method of claim 15, wherein measuring the flow and flow rate comprises detecting and measuring vibration in the pipe or conduit and detecting and measuring sound in the pipe or conduit in response to gas or liquid flowing through the pipe or conduit.

19. The method of claim 15, wherein reporting the comparison of the measured flow and flow rate with the established limits to an interface comprises reporting and displaying the comparison on a local signal interface comprising one of a meter, LEDs or an alarm.

20. The method of claim 15, wherein reporting the comparison of the measured flow and flow rate with the established limits to an interface comprises reporting the comparison to a remote interface.
